(19) United States
(12) Patent Application Publication
(10) Pub. No.: US 2004/0128644 A1
(43) Pub. Date: Jul. 1, 2004

(54) Software architecture for distributed enterprise business applications

(76) Inventors: Walter Hurst, San Francisco, CA (US); Kamal Prakash Shah, Oakland, CA (US)

Correspondence Address: Rahul Engineer, RDE Patent Group, 189 Collingwood St, San Francisco, CA, 94114, US

(21) Appl. No.: 10/692,771

(22) Filed: Oct. 24, 2003

Related U.S. Application Data
(60) Provisional application No. 60/421,495, filed on Oct. 25, 2002.

(51) Int. Cl. G06F 9/44

(52) U.S. Cl. 717/100

(57) ABSTRACT

A software architecture separating software application concerns from technical infrastructure concerns using manager objects and adapter objects. The manager objects are instanced from manager classes that define methods for receiving a client request, selecting an adapter class from a plurality of adapter class types based on the client request, instancing an adapter object from the selected adapter class, and delegating the client request to the selected adapter object. The adapter objects are instanced from adapter classes that define methods for receiving the client request from the manager objects, selecting an application component class from a plurality of application component class types based on the client request, instancing an application component from the selected application component class, and delegating the client request to the selected application component. The software architecture also provides a manager configuration, an adapter configuration, an adapter interface, and an application component interface.

### CROSS-REFERENCE TO RELATED APPLICATION

This application hereby claims the benefit under Title 35, U.S.C. §119(e) (1) of U.S. Provisional Patent Application No. 60/421,495, entitled Wakesoft Manager Adapter Distributed Business Application Architecture, filed Oct. 25, 2002, the disclosure of which is incorporated herein by reference in its entirety.

### FIELD OF THE INVENTION

The invention relates to data processing by a digital computer, and more particularly to software architectures for computer applications built on platforms such as Java 2 Enterprise Edition and Microsoft®.net.

### BACKGROUND OF THE INVENTION

Object-oriented programming languages such as Java 2 Enterprise Edition (J2EE) and Microsoft®.net provide businesses with powerful technical infrastructures they can use to build distributed enterprise business applications. Unfortunately, the lack of predefined organization within these technical infrastructures causes applications written on these platforms to be unnecessarily complex and inconsistent. This leads to a variety of problems in developing and building applications that are not addressed by existing tools and technologies.

One of the problems with known technical infrastructures for distributed enterprise business applications is that they allow unstructured programs to be written. Programmers who code business applications will often write a program that accomplishes the specific tasks assigned to them without adhering to any predefined, organized structure. As such, when multiple programmers work together to develop a distributed enterprise business application, code written by one programmer may not be easily compatible with code written by another programmer. Furthermore, different programmers may address the same technical issues in different ways. All of this presents problems and creates inconsistencies when the code from the different programmers is combined into one application. This unstructured code also provides for very little reuse, can be hard to maintain (especially if any of the original programmers are no longer available), provides no visibility into how the business requirements are implemented, and tends to solve the same problem in multiple ways which is not productive.

Another problem with known technical infrastructures for business applications is a lack of separation of concerns. Ideally, programmers should only work on the portions of a business application that they are most proficient at. For example, a programmer proficient at coding business logic should only work on business specific portions of the application and not technical portions. With known technical infrastructures, however, different programmers implementing and coding different portions of a business application are all exposed to the complexity of the technical infrastructure. This requires all of the programmers to have a sophisticated knowledge of the technical infrastructure being used to develop the business application. So programmers who are proficient at implementing business logic must be aware of and deal with technical portions of the business application as well. If these programmers are not proficient at the technical issues, they must do their best to address them. This puts the wrong people in charge of making technical decisions, thus leading to poor quality in the business application. This drawback of conventional distributed enterprise business applications makes it hard to align the right people with the right tasks, and impacts productivity.

Yet another problem with known technical infrastructures for business applications is that the lack of organization creates inflexible solutions. The lack of technical flexibility means applications cannot be easily changed when new requirements emerge or when problems are encountered. The lack of technical flexibility also increases costs associated with any technical change.

Accordingly, there is a need for methods or software that addresses the above mentioned problems to assist programmers in creating improved distributed enterprise business applications on technical infrastructures implementing object-oriented methods such as J2EE and Microsoft®.net.

### SUMMARY OF THE INVENTION

The invention is a software architecture that provides a bridge between a software application and its underlying technical infrastructure. The software architecture organizes the application into a set of reusable architectural services implemented with manager objects and adapter objects, while the functionality specific to the software application is organized into discrete application components. The manager objects are instances of provided manager classes and the adapter objects are instances of provided adapter classes. When a software application calls into the software architecture through a specific architecture service to request functionality, a manager object for that service is instantiated to receive the call. The manager object then instantiates the appropriate adapter object and delegates the call to that adapter object. The adapter object instantiates the appropriate application components to provide the functionality requested in the call.

The software architecture of the invention is composed of a plurality of architecture services, including a navigation service, a business process service, a persistence service, logging service, application state management service, data marshalling service, and a key management service. Each service has its own manager class and at least one adapter class. A service can communicate with another service by having its adapter objects or application components call the manager object of that other service. The use of a plurality of services allows the software architecture to separate different concerns of the software application, for instance, navigation functionality is separated from business specific functionality and persistence functionality. This enables application functionality for each service to be developed independent of the other services.

### DESCRIPTION OF THE DRAWINGS

FIG. 1A illustrates a conventional business application built directly on a technical infrastructure.

FIG. 1B illustrates a software architecture that provides a bridge between a business application and the underlying technical infrastructure.

FIG. 2 is an abstract illustration of the software architecture of the invention.

FIG. 3 is a UML figure of the software architecture of the invention.

FIG. 4 illustrates code for a manager configuration file.

FIG. 5 illustrates code for an adapter configuration file.

FIG. 6 illustrates a software architecture that includes a plurality of architecture services.

FIG. 7 is a UML figure of a navigation architecture service.

FIG. 8 is a UML figure of a business process architecture service.

FIG. 9 is a UML figure of a persistence architecture service.

FIG. 10 is a UML figure of a logging architecture service.

FIG. 111 is a UML figure of an application state management architecture service.

FIG. 12 is a UML figure of a data marshaling architecture service.

FIG. 13 is a UML figure of a key management architecture service.

FIG. 14 is a flowchart describing how a business application framework retrieves business functionality from the software architecture of the invention.

FIG. 15 is a flowchart describing the operation of the navigation service.

FIG. 16 is a flowchart describing the operation of the business process service.

FIG. 17 is a flowchart describing the operation of the persistence service.

### DETAILED DESCRIPTION

The invention is a software architecture that provides structure for software applications, separates different concerns of the application, and provides flexibility that enables changes to be made to software applications with ease relative to conventional applications. As used herein, the term “conventional application” refers to a software application written without the software architecture of the invention.

The software architecture of the invention defines a structure that can be used for many types of software applications, including but not limited to business applications and distributed enterprise business applications. For clarity, business applications are used herein to describe implementations of the invention. It should be noted, however, that the invention is not limited to business applications.

The structure provided by the software architecture of the invention can be visualized as a skeletal support that is used as a basis for building a software application. The structure defines intuitive and holistic software components that fill in this skeletal support. These software components are made to be independent so each software component can be replaced or amended without impacting other software components. This makes debugging and modifying a software application an easier task for users.

The software architecture of the invention separates different concerns of the software application. For instance, users who implement the software architecture of the invention to build applications tend to fall into two categories: technical programmers and application programmers. Accordingly, the software architecture of the invention generally separates technical code (i.e., technical components) required by the technical programmers from application-specific code (i.e., application-specific components) required by the application programmers. Since these software components are generally made to be independent, changes to one group of software components tend to not impact the other group of software components.

The software architecture of the invention also provides a simplified application programming interface that exposes functionality necessary to an application programmer but encapsulates the complexity of the technical infrastructure. This technical infrastructure can still be exposed to the technical programmer, or other technical users, outside of this application programming interface to modify and generate code to handle technical issues.

Additionally, the software architecture of the invention is flexible and configurable to enable a user to implement changes to a software application using methods that are relatively easier than methods used for modifying conventional applications. In an implementation of the invention, the software architecture utilizes adjustable configuration files to provide functionality that would normally be encoded directly into the software application. These configuration files can be easily modified as needed by a user to modify the behavior of the software application. The use of a configuration file therefore enable the re-use of software components and eliminate “hard-coding” of programming behavior in volatile areas that are likely to change through the life of a software application.

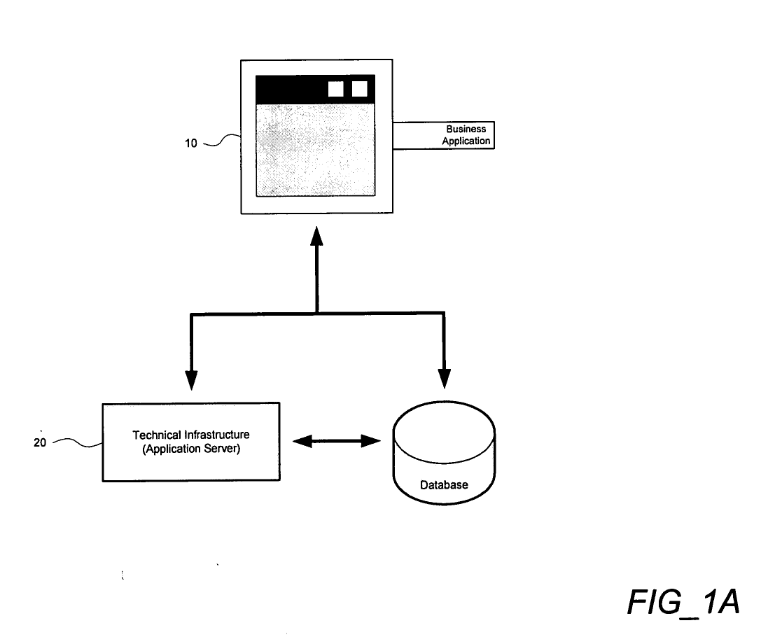

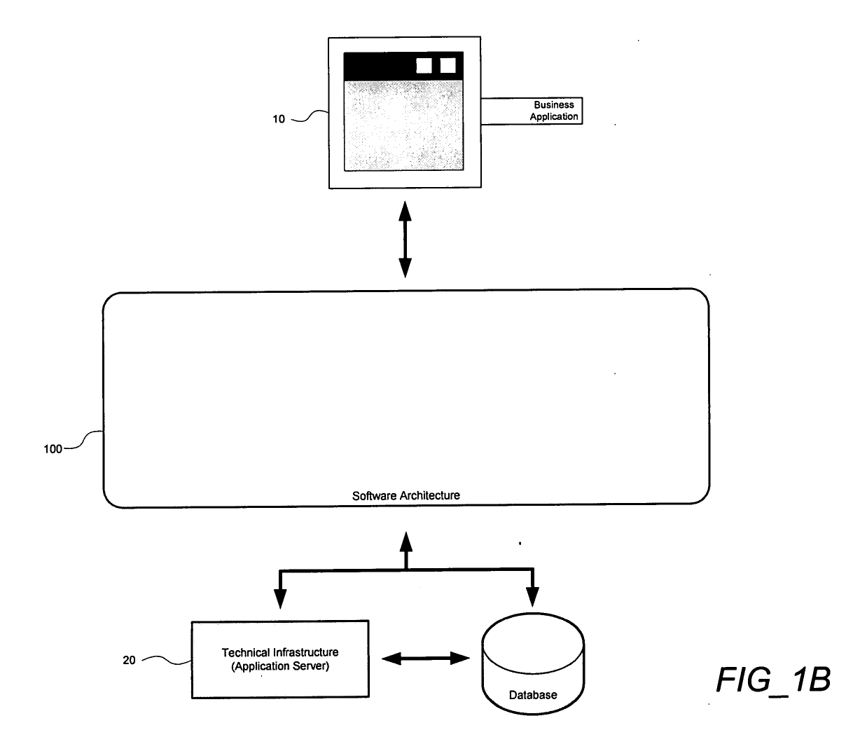

As shown in FIG. 1A, a conventional business application 10 is built directly on a technical infrastructure 20. The business application 10 is a computer program developed to carry out business-specific functionality. This functionality is implemented using methods developed and coded by a user. For example, a user familiar with the business requirements of an enterprise can write (i.e., code) and maintain business-specific logic for a business application that the enterprise desires. The underlying technical infrastructure 20 is the programming language platform used for the business application 10. The technical infrastructure 20 is generally implemented on a computer or an application server. In one implementation, the underlying technical infrastructure 20 is implemented as a J2EE-compliant or a Microsoft® net compliant application server. Building the business application 10 directly on the technical infrastructure 20 results in the business application 10 having technical code mixed in with business-specific code, leading to functional intermingling that becomes harder to debug and maintain as the business application 10 grows and matures, and as the business-specific logic changes.

FIG. 1B illustrates an implementation of a software architecture 100 constructed in accordance with the invention that provides a bridge between the business application 10 and the underlying technical infrastructure 20. The software architecture 100 provides a middleware layer between the business application 10 and the technical infrastructure 20 that contains structural code generally separating the business application concerns from the technical infrastructure concerns, and generally separating business software components from technical software components. The software architecture 100 provides a framework enabling the business application 10 to interact with the technical infrastructure 20 built on a platform such J2EE or Microsoft®.net.

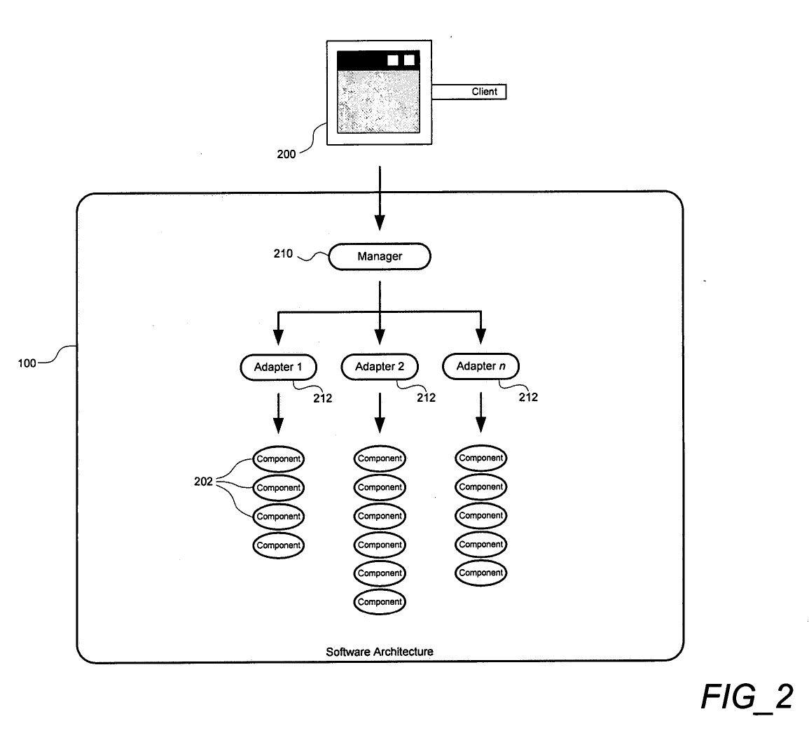

FIG. 2 illustrates an implementation of the invention where the software architecture 100 separates the technical, structural, and architectural functionality of a distributed application from its application-specific functionality. The technical, structural, and architectural functionality is common to all distributed applications and the software architecture 100 implements this functionality by providing reusable manager objects 210 and adapter objects 212, which are described in more detail below. The application-specific functionality, which is specific to a particular application, is provided by the software architecture 100 using one or more application components 202.

The application components 202 are discrete portions of code that contain focused functionality specific to the application. For example, if the application is a business application, the application components 202 provide the actual business functionality. An individual application component 202 generally focuses on only a particular piece of this functionality. Many application components 202 have no knowledge of the technical environment in which they are running. This allows those application components 202 to be greatly independent of their technical environment, enabling them to be reused in other parts of the business application or in completely different software applications. It should be noted that the application components 202 are generated by users of the software architecture 100; they are not provided by the software architecture 100.

In one implementation of the invention, a business application client 200 calls into the software architecture 100 to request some business functionality. The client 200 is any piece of software that can call into the software architecture 100 to make a request. The software architecture 100 uses the manager object 210 and at least one adapter object 212 to handle this incoming call. The manager object 210 receives and parses the incoming call to determine what is being requested by the client 200. The manager object 210 then selects an adapter object 212 that is configured to handle such a request and delegates the call to the selected adapter object 212. Each adapter object 212 is generally equipped to handle a plurality of tasks. The adapter object 212, upon receiving the call, determines what functionality is requested and calls the appropriate application components 202 to process the request. The use of manager objects 210 and adapter objects 212 to handle calls from the client 200 and to call application components 202 differs from conventional applications where the application code is in control and calls into libraries to accomplish certain specialized functions.

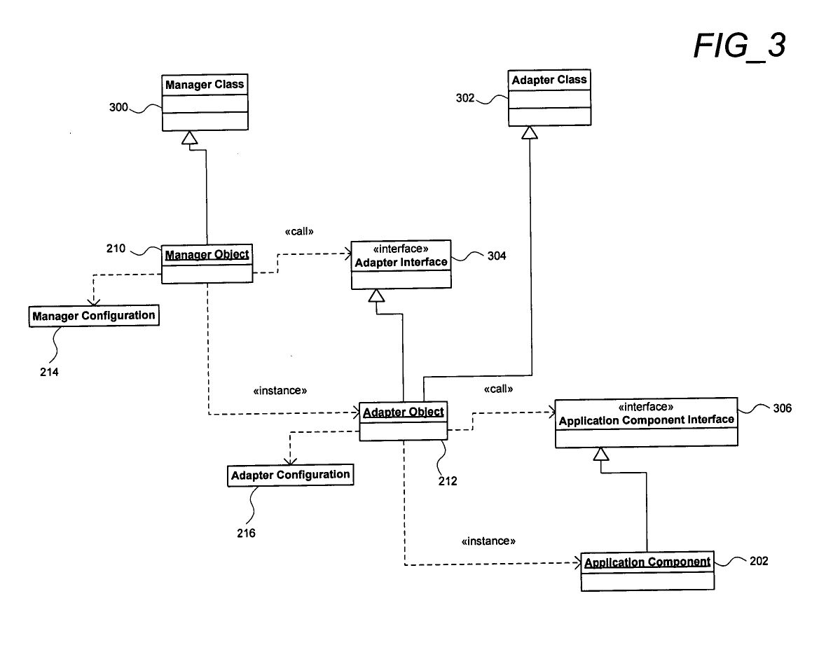

FIG. 3 is a unified modeling language (UML) diagram of the software architecture 100. In the implementation shown in FIG. 3, the technical infrastructure 20 is an object-oriented platform (e.g., J2EE), and the software architecture 100 provides at least one manager class 300. The manager class 300 is used by the software architecture 100 to instantiate a manager object 210. The manager class 300 defines all of the properties of the manager object 210, and can define functional methods relevant to incoming calls from the client 200. For instance, the manager class 300 can define a “save” method that is relevant to an incoming call requesting that a data object be stored in a database. As one of ordinary skill in the art will recognize, in object-oriented programming, a class is a template definition of the properties and behaviors, such as variables and methods, in a particular kind of object. Classes are used to instantiate (i.e., create) objects in memory. Thus, an object is a specific instance of a class; it contains real values instead of variables. A class can hove subclasses that can inherit all or some of the characteristics of the class. In relation to each subclass, the class becomes the superclass. Subclasses can also define their own methods and variables that are not part of their superclass. The structure of a class and its subclasses is called the class hierarchy.

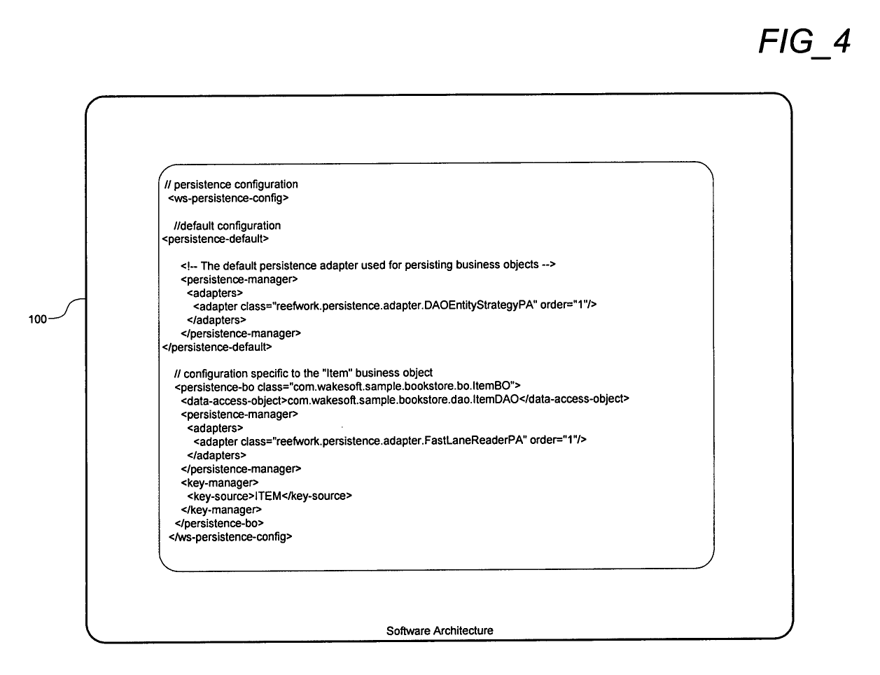

In an implementation of the invention, the software architecture 100 provides a manager configuration 214 that contains configuration data for the manager object 210. When a manager object 210 is instantiated, the manager object 210 retrieves configuration data from its corresponding manager configuration 214. The data in the manager configuration 214 provides the manager object 210 with methods, rules, and filters to apply to incoming calls from the client 200. This includes information specifying which adapter objects 212 to call for different requests from the client 200. A user can modify the behavior of a manager object 210 by modifying the manager configuration 214. This reduces the need to rewrite code for a manager object 210 or manager class simply to modify the behavior of the manager object 210. The manager object 210 can respond dynamically to changes in the configuration data included in the manager configuration file 214. FIG. 4 illustrates an implementation of a manager configuration file 214, written in J2EE code, for a manager object named “PersistenceManager.”

Returning to FIG. 3, in an implementation of the invention, the software architecture 100 also provides at least one adapter class 302. The adapter class 302 is used by the software architecture 100 to instantiate one or more adapter objects 212 and defines all of the properties and behaviors of the adapter objects 212. As is described below, the software architecture 100 can provide a separate adapter class 302 for each possible type of adapter object 212.

The adapter objects 212 are pluggable components of the software architecture 100. Since the adapter objects 212 are responsible for calling application components 202 to process requests, the adapter objects 212 provide a mechanism for a user, such as a technical programmer, to modify the behavior of the software architecture 100. This enables the interaction with the technical infrastructure 20 to be changed without modifying the manager objects 210, the application components 202, or the client 200, but by simply modifying the configuration to specify a different adapter object 212. The architecture 100 provides adapter objects 212 for various uses, but also allows technical programmers the option of building their own custom adapter object. This in turn provides a great amount of technical flexibility.

In an implementation of the invention, the software architecture 100 provides an adapter configuration 216 containing configuration data for the adapter objects 212. As is described below, in one implementation there is a separate adapter configuration 216 for each possible adapter object 212. When an adapter object 212 is instantiated, it retrieves configuration data from the adapter configuration 216.

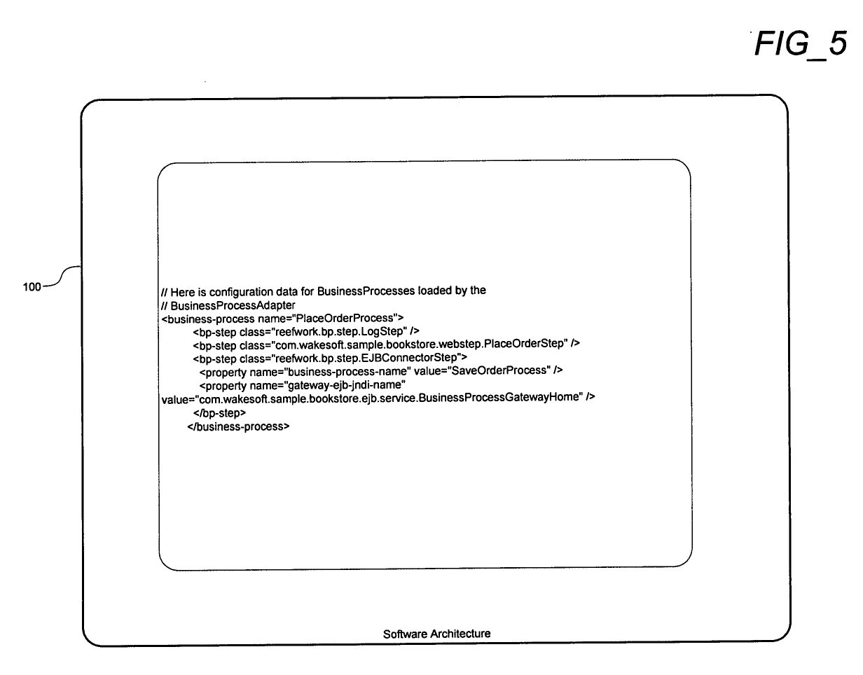

The data in the adapter configuration 216 provides the adapter object 212 with methods, rules, and filters to apply to incoming calls from the manager object 210. This includes information specifying which application components 202 to call for different requests from the client 200. A user can modify the behavior of the adapter object 212 by simply modifying the adapter configuration 216. The adapter object 212 can respond dynamically to changes in the configuration data. FIG. 5 illustrates an implementation of an adapter configuration 216 for an adapter named “BusinessProcessAdapter” written in Java code.

Returning again to FIG. 3, the software architecture 100 can provide one or more interfaces to be used in conjunction with the manager object 210 and the adapter objects 212. An interface provides templates of behavior that objects can implement. In one implementation, the software architecture 100 provides an adapter interface 304 that enables communications between the manager object 210 and the adapter object 212 to occur. More specifically, when the manager object 210 instances the adapter object 212, the adapter interface 304 provides methods to be implemented by the adapter object 212 so the manager object 210 can communicate with the adapter object 212.

As is described below, different manager objects 210 can be associated with different adapter interfaces 304. An adapter object 212 implemented for a specific manager object 210 must therefore implement that manager object's corresponding adapter interface 304.

The software architecture 100 can also provide one or more interfaces to be used in conjunction with the adapter objects 212 and the application components 202. Similar to the adapter interface 304, in one implementation, the software architecture 100 provides an application component interface 306 that enables communications between the adapter object 212 and the application components 202 to occur. The methods of the application component interface 306 must be implemented by the application components 202. An adapter object 212 can then instance an application component 202 and communicate with that application component 202 after the methods of the application component interface 306 have been implemented.

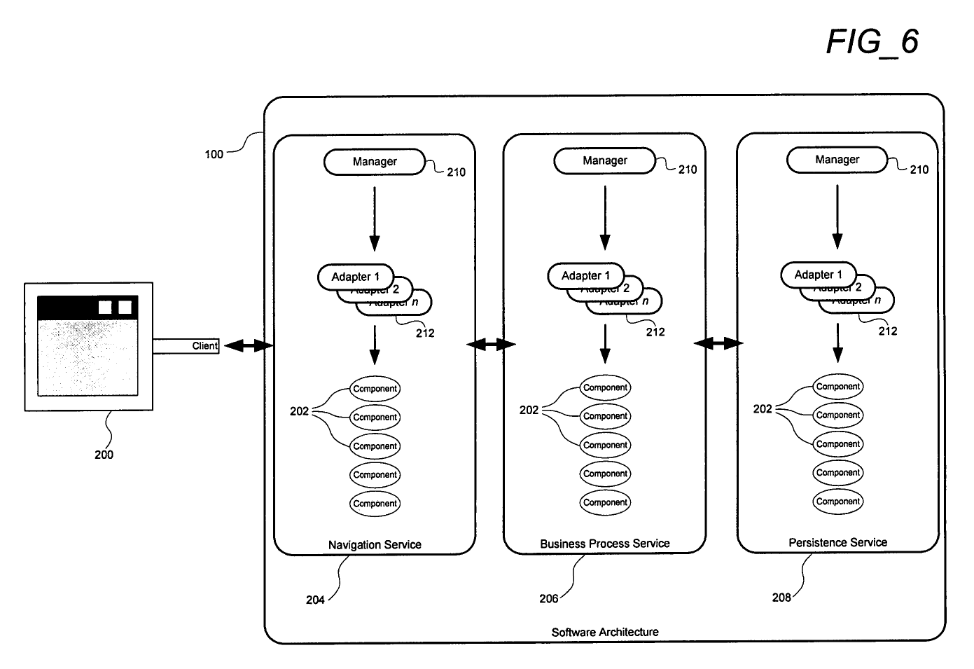

FIG. 6 illustrates an implementation of the invention where the software architecture 100 organizes its functionality into a plurality of architecture services. In this implementation, the software architecture 100 includes a navigation service 204, a business process service 206, and a persistence service 208. Each architecture service includes one manager object 210 and at least one adapter object 212 to provide technical, structural, and architectural functionality. Accordingly, the software architecture 100 provides a navigation manager class, a business process manager class, and a persistence manager class. Each architecture service also includes a separate manager configuration 214 for its manager object 210. In other implementations, additional architecture services can be included in the software architecture 100 to further organize or increase the functionality of the architecture.

The navigation service 204 can handle data communications with an end-user of the business application, for instance, through a graphical user interface (GUI). The navigation service 204 can display the GUI to an end-user and can also control the user interface flow or navigation. The business process service 206 can handle the processing of business logic contained in the business application. For example, if the business application is designed to handle banking transactions, the business process service 206 can carry out the associated banking transaction methods, such as transferring funds between accounts. Finally, the persistence service 208 can handle data persistence, such as creating, storing, retrieving, modifying, and deleting objects and data.

In one implementation, the client 200 initiates a request by calling into the navigation service 204 of the software architecture. The navigation service 204 can route the call to the appropriate service, such as the business process service 206 or the persistence service 208. In another implementation, the client 200 can call directly into the appropriate service it needs (e.g., the business process service 206). End-user interactions, however, are generally initiated at the navigation service 204.

In an implementation of the invention, each application component 202 is associated with at least one of the services. The software architecture 100 takes application components 202 containing navigation functionality and associates them with the navigation service 204. Likewise, the software architecture 100 associates business logic application components 202 with the business process service 206, and persistence application components 202 with the persistence service 208.

In one implementation, each service provided by the software architecture 100 can include one or more application component interfaces 306 to be implemented by the application components 202 associated with that service. In an implementation of the invention, each adapter object 212 is associated with a specific application component interface 306, and an application component 202 instanced and called by that adapter object 212 can implement that specific application component interface 306.

Users, such as the business programmers described above, generate the application components 202 using protocols imposed by the software architecture 100 and the relevant architecture service. In one implementation, one such protocol is that application components 202 must implement the application component interface 306 defined by the relevant architecture service. The service can then call the application components 202 through that application component Interface 306. In an implementation, another such protocol is that the application components 202 must be added to the configuration 216 for an architectural service in a specified format so that they can be read and loaded. The application components 202 of one service can be developed independent from the application components 202 of another service. As such, different users can develop different application components 202 independently of each other.

The organization of the application components 202 into different services allows users developing portions of a business application to work within a specific service without having to address issues from other services. So a user proficient at developing business logic can generate business logic application components 202 without having to address navigation or persistence issues. Similarly, a user experienced at developing graphical user interfaces can focus on generating navigation application components 202, while a technical user familiar with the technical infrastructure can develop the persistence application components 202. The software architecture 100 then assembles these different application components 202 to form one coherent business application.

The manager object 210 is the primary point of interaction for the architecture service. Since only one manager object 210 is defined for each architecture service, a relatively small number of manager objects 210 exist, thereby reducing the complexity of the software architecture 100 from the perspective of the client 200. The client 200 can then access the functionality contained in the software architecture 100 by simply communicating with the small number of manager objects 210.

When the functionality of an architecture service is needed by a user coding a client 200, the user need only write code that calls the manager object 210 associated with the required service. The user does not have to write code that includes the functionality of the service. Thus, the manager object 210 provides an abstraction of the service for the user which simplifies the development of a business application. Decision-making processes are handled by the manager object 210 once it is called, thereby removing that task from the user. The manager object 210 calls an adapter object 212 that encapsulates the actual behavior. The manager object 210 communicates with the adapter object 212 through the adapter interface 304 defined for the relevant architectural service.

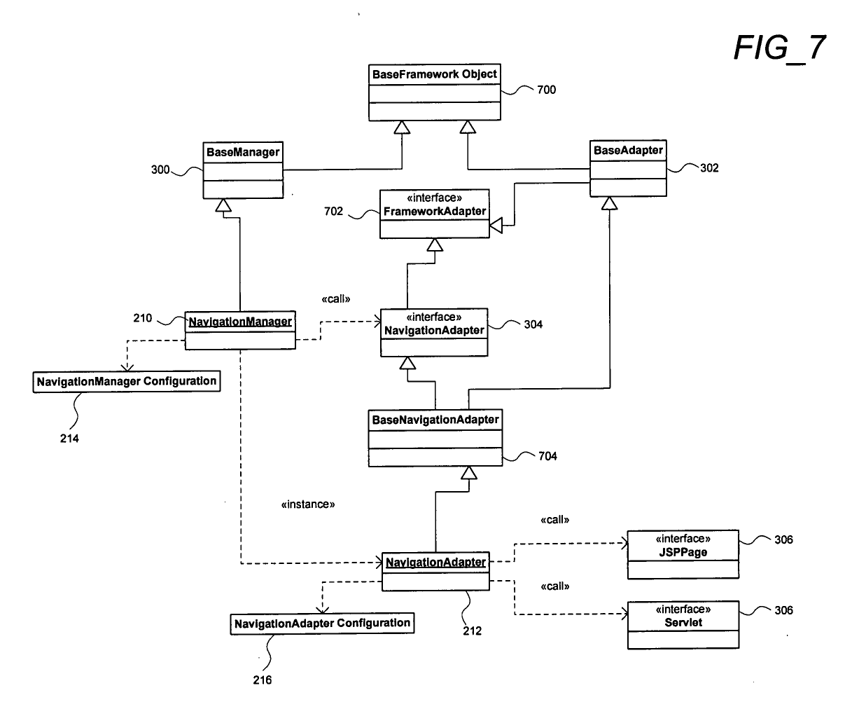

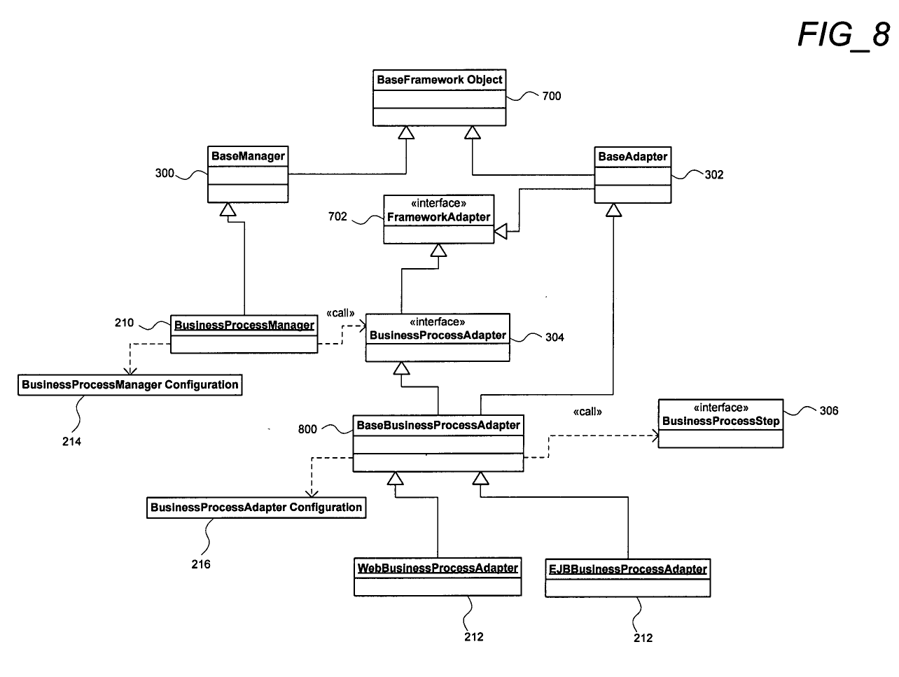

FIG. 7 is a UML diagram of one implementation of the navigation architecture service 204 provided by the software architecture 100. For this implementation (as well as the implementations described in FIGS. 8 through 13), the technical architecture 20 is a J2EE application server. In other implementations, however, other technical architectures can be used. It should be noted that the names used for the objects discussed in FIGS. 7 through 13 below are merely for explanatory purposes and should in no way be construed as imposing limitations on the invention.

In the implementation of FIG. 7, the software architecture 100 provides a root class 700 called BaseFrameworkObject 700, which is based on the java.lang.Object class provided in the J2EE technical infrastructure. The root class 700 can add at least one method to the java.lang.Object class, for instance, a method to return the class name for the instance of this object. The root class 700 can serve as the root object for all objects used by the software architecture 100, which facilitates adding behavior that will be common to all of them. This also allows all of the software architecture 100 objects to be referenced in a uniform fashion that can be more useful than java.lang.Object.

The software architecture 100 provides a manager class 300, called BaseManager class 300, which extends the root class 700. The BaseManager class 300 functions as a superclass for all of the manager classes and facilitates adding behavior that will be common to just the manager objects 210. Using the BaseManager class 300, the software architecture 100 instantiates a manager object 210 called NavigationManager object 210. The NavigationManager object 210 extends the BaseManager class 300 and functions as the manager object 210 for the navigation service 204. The NavigationManager object 210 can implement one or more methods to process incoming calls, select adapter objects 212, and delegate calls to the selected adapter objects 212. The NavigationManager object 210 loads configuration data from the manager configuration 214 (referred to here as NavigationManager configuration 214).

The software architecture 100 provides an adapter class 302, called BaseAdapter class 302, which is also based on the root class 700 (i.e., BaseFrameworkObject) provided by the software architecture 100. The BaseAdapter class 302 extends the root class 700 and functions as a superclass for all of the software architecture 100 adapter classes. The BaseAdapter class 302 facilitates adding behavior that will be common to just the adapter objects 212, regardless of the service in which the adapter object 212 is used. The BaseAdapter class 302 implements an interface 702, called FrameworkAdapter interface 702, which functions as a superclass for all software architecture 100 adapter interfaces and facilitates adding behavior that will be common to all of them.

Next, the software architecture 100 provides a navigation adapter class 704, called the BaseNavigationAdapter class 704, which extends the BaseAdapter class 302 and functions as a superclass for all adapter classes associated with the navigation service 204. This BaseNavigationAdapter class 704 facilitates adding behavior that will be common to just the navigation service adapter objects 212.

The BaseNavigationAdapter class 704 implements an adapter interface 304 called NavigationAdapter interface 304. This is the adapter interface 304 specified by the navigation service 204. The NavigationAdapter interface 304 provides methods to be implemented by the BaseNavigationAdapter class 704 so that the navigation manager object 210 (i.e., NavigationManager object 210) can communicate with the navigation adapter objects 212 instantiated from the BaseNavigationAdapter class 704. In one implementation, the NavigationAdapter interface 304 can add methods to process incoming calls, to determine if the cached adapter should be invalidated, and to display a page as the response to an end-user.

The software architecture 100 instantiates one or more adapter objects 212 from the BaseNavigationAdapter class 704. In one implementation, as shown in FIG. 7, a NavigationAdapter object 212 is instantiated from the BaseNavigationAdapter class 704. The NavigationAdapter object 212 loads configuration data from an adapter configuration file 216, such as the NavigationAdapter configuration 216. The NavigationAdapter object 212 can use known J2EE interfaces to carry out navigation functionality, for instance, by using J2EE application component interfaces 306 such as JSPPage and Servlet.

FIG. 8 is a UML diagram illustrating one implementation of a business process architecture service 206 used in the software architecture 100. Similar to the NavigationManager object 210 in FIG. 7, the software architecture 100 uses the BaseManager class 300 to instantiate a manager object 210, in this case BusinessProcessManager 210, which serves as the manager object 210 for the business process service 206. The BusinessProcessManager object 210 can execute business processes by looking up the appropriate adapter object 212 to handle the business process and then delegating the call to that adapter object 212. The BusinessProcessManager object 210 loads configuration data from the manager configuration 214 (referred to here as BusinessProcessManager configuration 214).

The software architecture 100 also provides business process adapter classes for the business process service 206. Using the BaseAdapter class 302 described above, the software architecture 100 can provide a BaseBusinessProcessAdapter class 800 that extends the BaseAdapter class 302 and functions as a superclass for all of the adapter objects 212 associated with the business process service 206. The BaseBusinessProcessAdapter class 800 can access configuration data from an adapter configuration file 216, such as the BusinessProcessAdapter configuration 216.

The BaseBusinessProcessAdapter class 800 implements an adapter interface 304, in this case BusinessProcessAdapter interface 304, as required by the business process service 206. The BusinessProcessAdapter interface 304 provides methods implemented by the business adapter objects 212 to allow the business manager object 210 (i.e., BusinessProcessManager 210) to communicate with the business adapter objects 212.

The BaseBusinessProcessAdapter class 800 also implements an application component interface 306, in this case the BusinessProcessStep interface 306. This application component interface 306 provides methods enabling the adapter objects 212 to communicate with application components 202 that contain business logic for executing business process steps. For example, an application component 202 can be included that contains business logic invoked as part of a business process. A business process is the logical grouping of a sequence of steps.

The software architecture 100 can provide a BusinessProcessAdapter class (not shown) that extends the BaseBusinessProcessAdapter class and contains most of the default behavior for the adapter objects 212 used in the business process service 206. The adapter objects 212 can then be instantiated from either the BaseBusinessProcessAdapter class 800 or the BusinessProcessAdapter class, depending on the functionality required.

Finally, because there is specialized behavior for adapter objects 212 that interface with HTTP requests (e.g., over the Internet) or with Enterprise Java Beans (EJB), separate objects can be provided for these functions. As shown in FIG. 8, the software architecture 100 instantiates a WebBusinessProcessAdapter object 212 and an EJBBusinessProcessAdapter object 212. Incoming HTTP calls are handled by the WebBusinessProcessAdapter object 212, while ELB calls are handled by the EJBBusinessProcessAdapter object 212. These are just two of the many possible adapter objects 212 that can be implemented by the business process service 206.

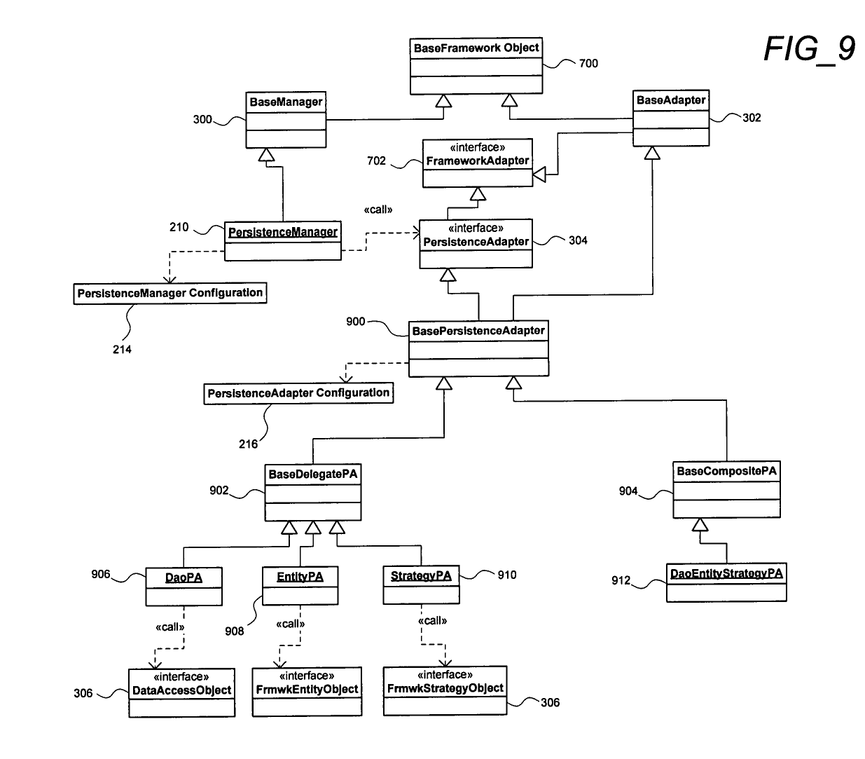

FIG. 9 is a UML diagram illustrating one implementation of a persistence architecture service 206 used in the software architecture 100. In this implementation, the software architecture 100 uses the BaseManager class 300 to instantiate a manager object 210 for the persistence service 208 referred to as the PersistenceManager object 210. The PersistenceManager object 210 can use adapter objects 212 to carry out methods for interacting with the persistence mechanism, such as a database, an extensible markup language (XML) file, or other storage devices. The PersistenceManager object 210 can also add methods to enable persistence functionality, such as a method to delete application objects, a method to call an adapter object 212, a method to store application objects, and a method to retrieve application objects. The PersistenceManager object 210 loads configuration data from the manager configuration 214, referred to as the PersistenceManager configuration 214.

The software architecture 100 provides persistence adapter classes for the persistence service 208. In this implementation, the software architecture 100 provides an adapter class called the BasePersistenceAdapter class 900 that extends the provided BaseAdapter class 302 and can be used as a superclass for the persistence adapter objects 212. A PersistenceAdapter interface 304 is provided for the BasePersistenceAdapter 900 to establish methods, implemented by the adapter objects 212, that enable communications with the manager object 210 (i.e., PersistenceManager object 210), as well as whatever persistence mechanism the software employs. The BasePersistenceAdapter 900 can also load configuration data from the PersistenceAdapter configuration 216.

Next, the software architecture 100 provides two subclasses for the BasePersistenceAdapter class 900, a BaseDelegatePA class 902 and a BaseCompositePA class 904. The BaseDelegatePA class 902 is a superclass for delegate persistence adapters that can be combined together by composite persistence adapters. The BaseCompositePA class 904 functions as a superclass for the composite persistence adapters, which can combine multiple delegate persistence adapters.

The BaseDelegatePA class 902 can have a number of subclasses that are used to instantiate adapter objects 212 for use in the persistence service 208. For instance, a DaoPA class 906 extends the BaseDelegatePA class 902 and utilizes data access objects for the persistent storage of a business object. Similarly, an EntityPA class 908 utilizes entity EJBs for the persistent storage of a business object, and a StrategyPA class 910 utilizes strategy session EJBs for the persistent storage of a business object. Application component interfaces 306 can be implemented to enable communications between adapter objects 212 instantiated from these subclasses and their associated application components 202.

The BaseCompositePA class 904 can also have a number of subclasses that are used to instantiate adapter objects 212 for the persistence service 208. For instance, the BaseCompositePA class 904 can include a DAOEntityStrategyPA class 912 to utilize data access objects, entity EJBs, and strategy session EJBs for the persistent storage of a business object, a DAOLEntityStrategyPA class (not shown) to utilize data access objects, local entity EJBs, and strategy session EJBs for the persistent storage of a business object, a DAOStrategyPA class (not shown) to utilize data access objects and strategy session EJBs for the persistent storage of a business object, an EntityStrategyPA class (not shown) to utilize both entity EJB and strategy session EJBs for the persistent storage of a business object, and a FastLaneReaderPA class (not shown) to utilize data access objects, entity EJBs, and strategy session EJBs for the persistent storage of a business object, except when handling collections. In one implementation, application components 202 can be provided to perform object relational mapping between a business object and the persistence storage. Other application components 202 can contain other logic needed for business object persistence.

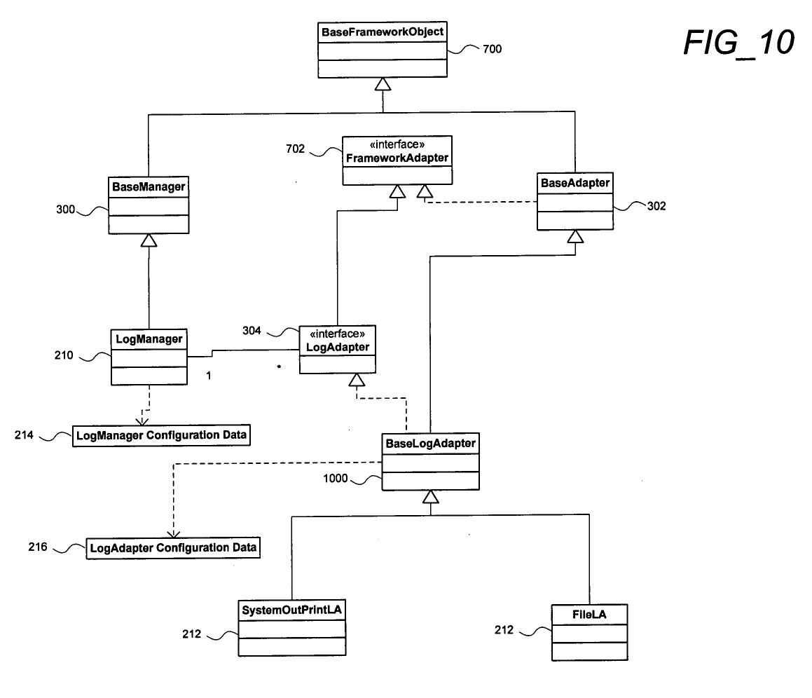

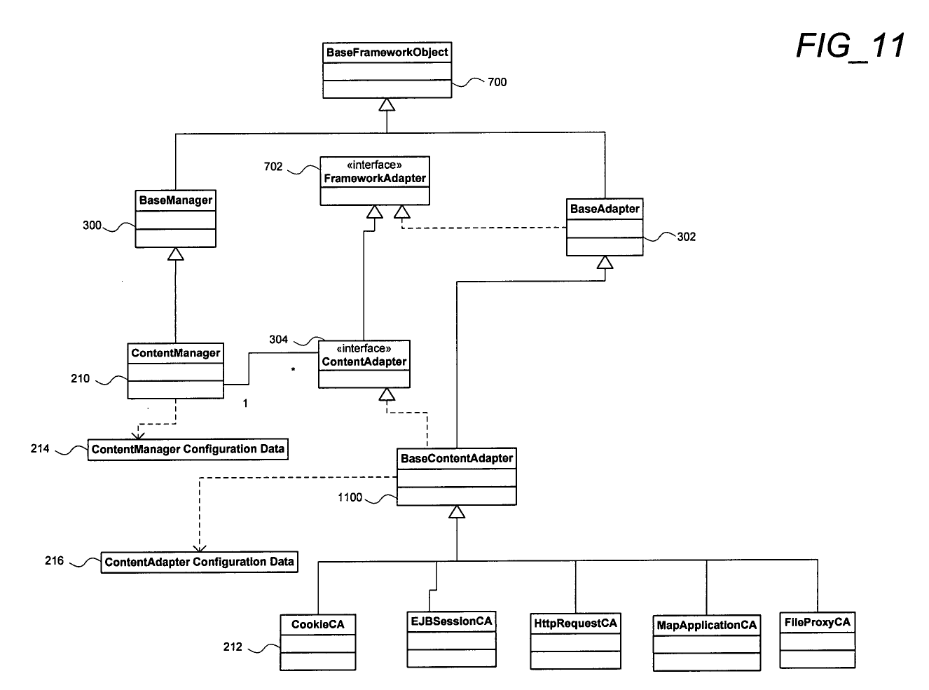

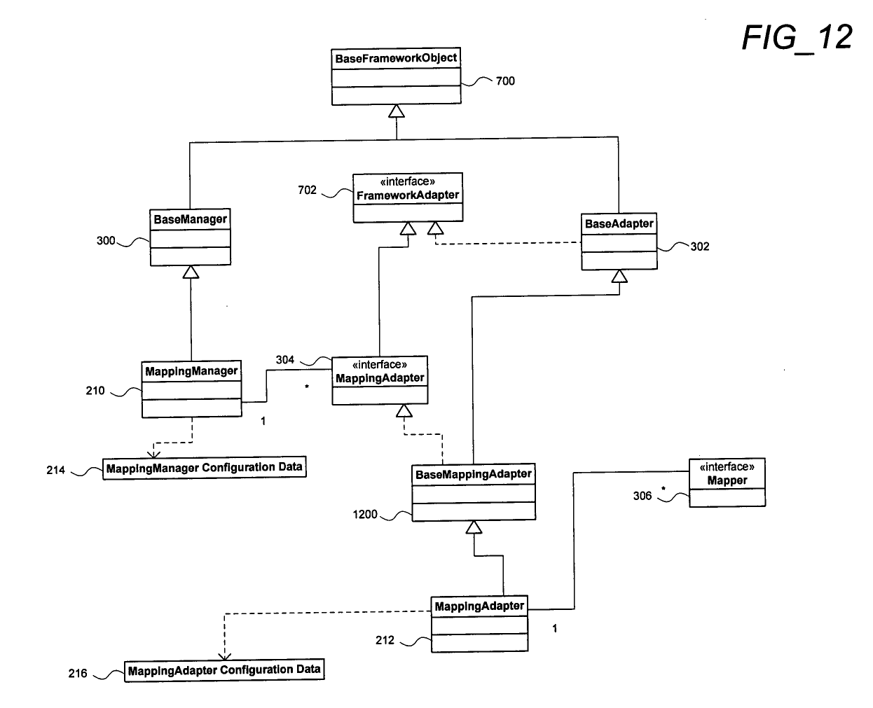

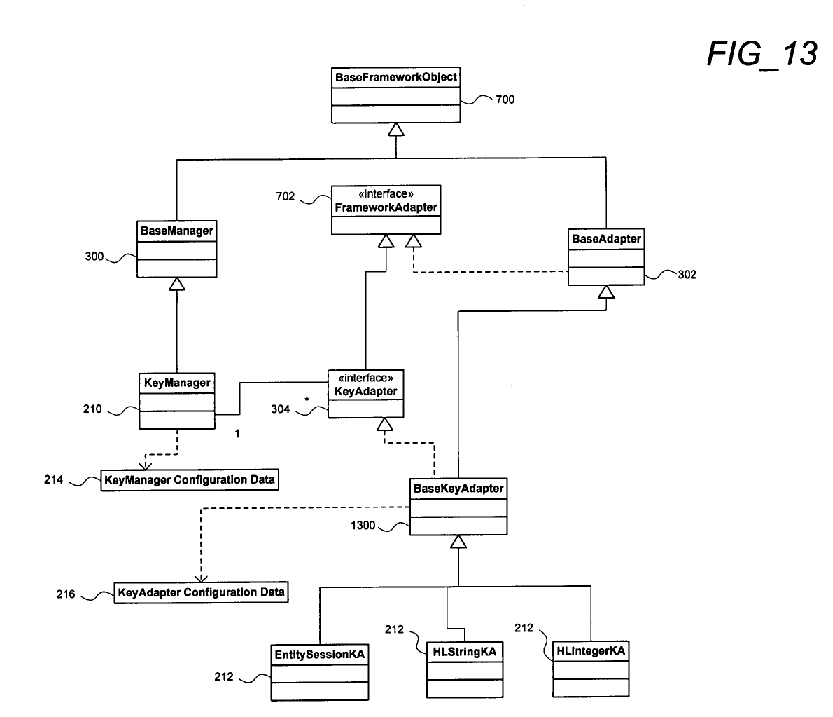

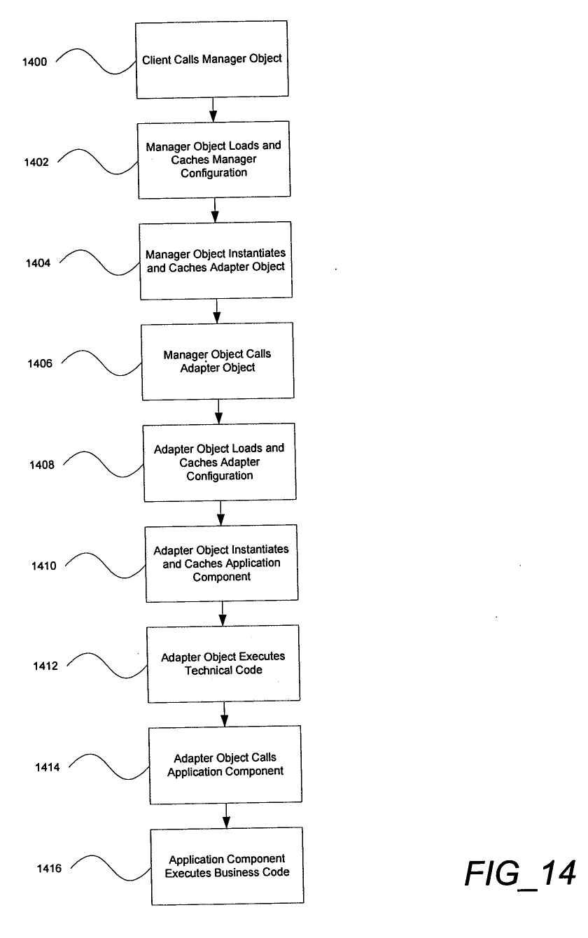

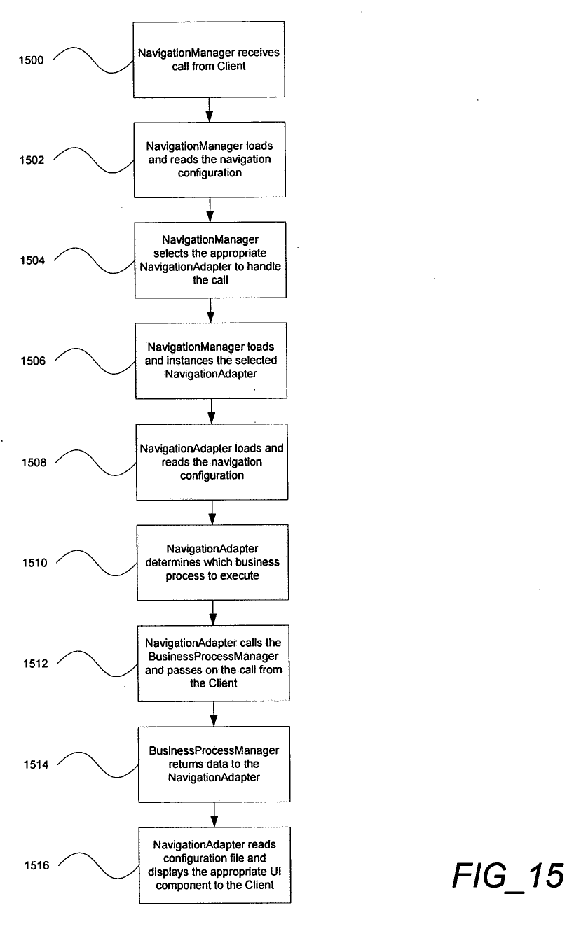

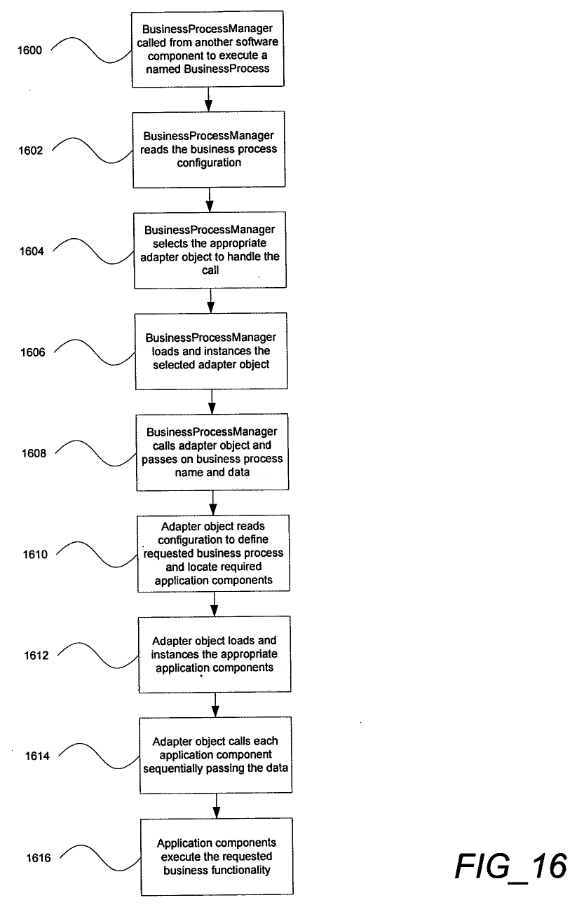

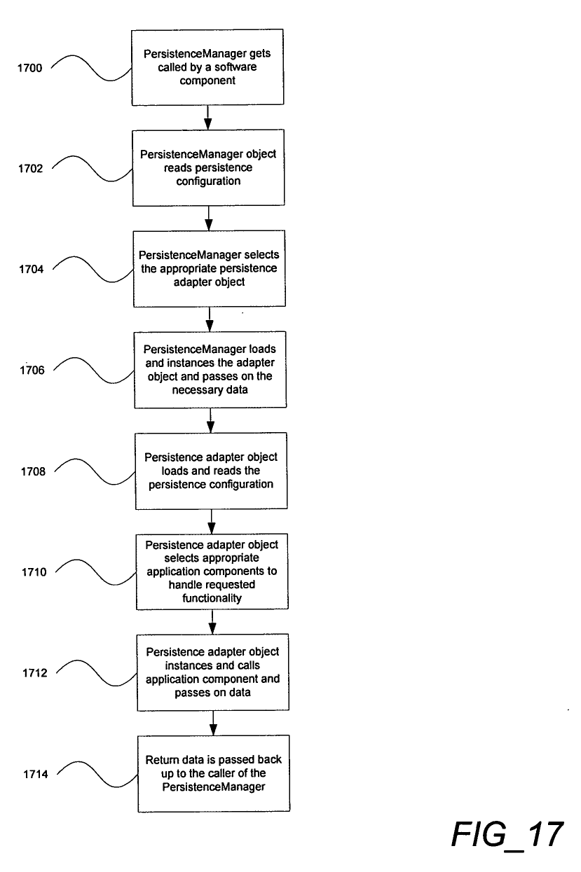

The software architecture 100 can provide further manager/adapter classes and architecture services in addition to the ones described above. FIG. 10 is a UML diagram of one implementation of a logging architecture service provided by the software architecture 100. Logging functionality outputs messages from the application for many purposes including debugging, error handling, and informational purposes. The logging service can log messages of different severities to some standard repository.

As discussed above, the software application 100 provides a BaseManager class 300 and a BaseAdapter class 302 from which manager and adapter objects or classes can be generated. In the logging service, the software architecture 100 instantiates a LogManager object 210 from the BaseManager class 300. The LogManager object 210 serves as the manager object 210 of the logging service and loads configuration data from a LogManager configuration 214. The LogManager class can define methods to log a message with the debug severity and to log a message with the error severity.

The software architecture 100 also generates a BaseLogAdapter class 1000 from the BaseAdapter class 304. The BaseLogAdapter class 1000 implements a LogAdapter interface 304 and loads configuration data from a LogAdapter configuration 216. Adapter objects 212 can be instantiated from the BaseLogAdapter class 1000. For instance, a SystemOutPrintLA object 212 and a FileLA object 212 can be instantiated. The SystemOutPrintLA object 212 logs all messages to standard output and the FileLA object 212 logs all messages to a file.

FIG. 11 is a UML diagram of one implementation of an application state management architecture service provided by the software architecture 100. This service is used to cache and retrieve data, for example, to manage any content that needs to be stored on the server for the convenience of retrieving it at a later time. The software application 100 again provides a BaseManager class 300 and a BaseAdapter class 302 from which manager and adapter objects or classes can be generated. In the application state management service, the software architecture 100 instantiates a ContentManager object 210 from the BaseManager class 300. The ContentManager object 210 serves as the manager object 210 of the application state management service and loads configuration data from a ContentManager configuration 214. The ContentManager class can define methods to retrieve content and to store content.

The software architecture 100 also generates a BaseContentAdapter class 1100 from the BaseAdapter class 304. The BaseContentAdapter class 1100 implements a ContentAdapter interface 304 and loads configuration data from a ContentAdapter configuration 216. Subclasses to the BaseContentAdapter class 1100 can be provided to instantiate adapter objects 212, or adapter objects 212 can be instantiated directly from the BaseContentAdapter class 1100. In an implementation, the software architecture provides the following adapter classes or adapter objects 212: a CookieCA adapter class to deal with content stored or retrieved from cookies; an EJBSessionCA adapter class to store and retrieve content from a session EJB; a FileProxyCA adapter class to allows access to files for the business application; an HttpRequestCA adapter class to store and retrieve content from an HTTP request; an HttpSessionCA adapter class to store and retrieve content from an HTTP session (not shown); and a MapApplicationCA adapter class to store and retrieve content in a application wide repository backed by a Java Map collection object. Using the application state management service masks the intricacies of dealing with the underlying storage mechanisms.

FIG. 12 is a UML diagram of one implementation of a data marshalling architecture service provided by the software architecture 100. Data marshalling handles the conversion of data from one format to another. Each adapter object 212 in the data marshalling service can have a different mechanism for converting data, and can support one or more types of conversions. A typical example of a conversion is converting data from objects to XML.

As before, the software application 100 provides a BaseManager class 300 and a BaseAdapter class 302 from which manager and adapter objects or classes can be generated. In the data marshalling service, the software architecture 100 instantiates a MappingManager object 210 from the BaseManager class 300. The MappingManager object 210 serves as the manager object 210 of the data marshalling service and loads configuration data from a MappingManager configuration 214. The MappingManager class can define methods such as for extracting information contained in an object and for populating an object.

The software architecture 100 also generates a BaseMappingAdapter class 1200 from the BaseAdapter class 304. The BaseMappingAdapter class 1200 implements a MappingAdapter interface 304 and loads configuration data from a MappingAdapter configuration 216. The software architecture 100 can instantiate an adapter object 212 from the BaseMappingAdapter class 1200, such as a MappingAdapter object 212. The MappingAdapter object 212 can perform XML data binding for both marshaling and unmarshaling, for instance, marshaling objects into their XML representation and unmarshaling XML representations to generate and/or populate objects. The MappingAdapter 212 loads configuration data from a MappingAdapter configuration 216 and communicates with application components 202 through a Mapper application component interface 306.

In an implementation, the software architecture 100 can provide one adapter class for handling the marshaling and unmarshaling of business objects and business object collections, one adapter class for handling the marshaling and unmarshaling of event objects containing business objects, business object collections, application exceptions, and process names, one adapter class for handling the marshaling and unmarshaling of java.util.Map objects, one adapter class to provide a default adapter implementation for the MappingManager and to function as a superclass for custom adapter objects 212 associated with the MappingManager, one adapter class to use session or entity EJBs for the generation and obtaining of primary keys for business objects, and one adapter class to use session EJBs for the generation and obtaining of primary keys for business objects.

FIG. 13 is a UML diagram of one implementation of a key management architecture service provided by the software architecture 100. Key management handles the generation of unique identifiers (i.e., keys) for relevant objects. Each adapter object 212 used in this service can use a different mechanism to generate unique keys. The software application 100 again provides a BaseManager class 300 and a BaseAdapter class 302 from which manager and adapter objects or classes can be generated. In the key management service, the software architecture 100 instantiates a KeyManager object 210 from the BaseManager class 300. The KeyManager object 210 serves as the manager object 210 of the key management service and loads configuration data from a KeyManager configuration 214. The KeyManager class can define methods to construct a new primary key of the correct type for the object with a valid value and to return the field name that is used by the software application to contain the primary key value when marshaling and unmarshaling data.

The software architecture 100 also generates a BaseKeyAdapter class 1300 from the BaseAdapter class 304. The BaseKeyAdapter class 1300 implements a KeyAdapter interface 304 and loads configuration data from a KeyAdapter configuration 216. The software architecture 100 can instantiate an adapter object 212 from the BaseKeyAdapter class 1300, such as an EntitySessionKA 212 that uses either session or entity EJBs for the creation and obtaining of Primary Keys for business objects, a HLStringKA 212 that uses session EJBs for the creation and obtaining of primary keys for business objects, and a HLlntegerKA 212 that also uses session EJBs for the creation and obtaining of Primary Keys for business objects.

FIG. 14 is a flowchart illustrating one implementation of how the client retrieves business functionality from the software architecture. The client begins by calling a manager object in the software architecture (step 1400). If no manager object exists at the moment the business application framework calls into the software architecture, a manager object can be instantiated from the appropriate manager class.

Once the manager object is instantiated, the manager object loads and caches the manager configuration data instructing the manager object on how to delegate different calls from the business application framework to the appropriate adopter object (step 1402). The manager object parses the call and selects an adapter class based at least in part on the instructions in the manager configuration, and the manager object instantiates and caches an adapter object from the selected adapter class (step 1404). The manager object calls the instantiated adapted object and delegates to it the call from the client (step 1406).

The adapter object, after it has been instantiated, loads and caches the adapter configuration data instructing the adapter object on how to handle different calls from the client (step 1408). The adapter object instantiates and caches the appropriate application component or components to handle the request from the client based on the data in the adapter configuration (step 1410). The application components can be provided as classes by the user; application components can then be instantiated from the appropriate class when needed. Alternatively, the application components can be provided as objects and do not have to be instantiated by the adapter object.

The adapter object can execute any technical code that is required by the request from the client (step 1412). The adapter object then calls the application component (step 1414), and the application component executes the business code for which it was developed (step 1416). The execution of the business code generally results in some form of output being returned to the client.

FIG. 15 is a flowchart describing one implementation of the operation of the navigation service 204. The navigation service displays the graphical user interface (GUI) to an end-user and controls the user interface flow, known as navigation. In this implementation, the navigation service instantiates a NavigationManager object as described above, and implements the NavigationAdapter interface. The NavigationManager object can instantiate an adapter object such as a NavigationAdapter object. Application components, such as application components used for the user interface (e.g., application components to generate HTML pages and JSP pages), can be instantiated by the adapter object.

When a request from an end-user is received from the client, it is sent as a call into the navigation service and received by the NavigationManager object (step 1500). The NavigationManager object loads and reads the navigation configuration (step 1502), and based at least in part on the instructions in the configuration, selects the NavigationAdapter to handle the call from the client (step 1504).

The NavigationManager object loads and caches the selected NavigationAdapter object (step 1506), and passes the call to the NavigationAdapter object. The NavigationAdapter object then loads and reads the navigation configuration (step 1508). In some implementations, the configuration for the manager is different than the configuration for the adapters, while in other implementations the same configuration can be used for both. Next, the NavigationAdapter object, based at least in part on the instructions in the configuration, determines which business process is being requested by the call (step 1510).

To execute the business process, the NavigationAdapter object calls the BusinessProcessManager from the business process service and passes the call from the client on to the BusinessProcessManager object (step 1512). The call from the client is a request that generally contains the name of the business process to execute and the user data necessary to carry out the process.

After the BusinessProcessManager object processes the call, it returns data to the NavigationAdapter object (step 1514). The NavigationAdapter object reads the navigation configuration that contains rules specifying which user interface component to display based on the data returned from the BusinessProcessManager object (step 1516). Based on this data, the NavigationManager object displays the appropriate user interface component to the client (step 1516).

FIG. 16 is a flowchart describing one implementation of the operation of the business process service 206. As explained above, the business process service manages and executes the business logic of the application. In this implementation, the business process service can instantiate and use a BusinessProcessManager object, and can implement a BusinessProcessAdapter interface as its adapter interface. The business process service can instantiate adapter objects as required, the EJBBusinessProcessAdapter and the WebBusinessProcessAdapter being two examples. The business logic requirements map to business process steps which implement the business logic and are executed by the BusinessProcessManager object.

The BusinessProcessManager is generally called from another software component, such as the navigation service, to execute a named business process (step 1600). For example, if the business process is for banking transactions, the named business process can be called TransferFundsProcess. The incoming call generally includes the name of the business process to execute and the data required to execute the process. The BusinessProcessManager object reads the business process service configuration (step 1602) and selects the appropriate adapter object (e.g., the EJBBusinessProcessAdapter object) specified for the business process requested in the call (step 1604). The configuration provides instructions used by the BusinessProcessManager object to select and instantiate the appropriate adapter object.

The BusinessProcessManager loads and instances the selected adapter object (step 1606). The BusinessProcessManager then calls that adapter object and passes on the name of the requested business process and the data required to execute the process to the adapter object (step 1608). The adapter object reads the business service configuration and finds the definition for the requested business process (step 1610). The configuration also enables the adapter object to locate and retrieve the appropriate application components specified for the named business process (step 1610). The adapter object then loads and instances the appropriate application components needed to carry out the requested business process (step 1612). For example, if the requested business process is the TransferFundsProcess mentioned above, the appropriate application components could be a DebitAccountStep object and a CreditAccountStep object.

The adapter object calls each application component sequentially passing the data (step 1614), and the application components execute the requested business functionality (step 1616). For example, in the TransferFundsProcess, the DebitAccountStep object can remove money from a first account, and the CreditAccountStep object can add money to a second account.

FIG. 17 is a flowchart describing one implementation of the operation of the persistence service 208. The persistence service performs persistence operations (i.e., create, retrieve, update, and delete) on the objects/data of the business application. Different persistence adapters are provided for different technical persistence mechanisms. In this implementation, the persistence service can instantiate and use a PersistenceManager object, and can implement a PersistenceAdapter interface. The persistence service can also instantiate adapter objects, such as a DaoPA object, an EntityPA object, a StrategyPA object, an EmailPA object, a FastLaneReaderPA object, as well as many other adapter objects. The application components that can be called by these adapter objects can include a Dao object, a StrategyEJB object, and an EntityEJB object.

In the persistence service, the PersistenceManager is generally called by a software component, such as a business application component from the business process service (step 1700). The call includes the appropriate data needed to carry out the persistence functionality. The PersistenceManager object reads persistence service configuration (step 1702) and selects the appropriate persistence adapter object based on the data that is passed in and based on the instructions in the configuration (step 1704). The PersistenceManager object then loads and instances the selected adapter object (e.g., the DaoPA object) (step 1706), and passes the necessary data on to the adapter object (step 1706).

The persistence adapter object loads and reads the persistence configuration (step 1708) and selects the appropriate application component to handle the requested persistence functionality (step 1710). The persistence adapter object then instances and calls the application component and passes the data on to the application component (step 1712). The return data from the application component after the functionality is carried out is passed back up to the caller of the PersistenceManager (step 1714).

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

The software architecture of the invention therefore separates the difficult technical challenges associated with the production of a business application. As described herein, the software architecture accomplishes this by defining how to develop business components in a way that is independent of the underlying technologies. Developers who use the software architecture of the invention can invest significantly less time becoming familiar with distributed infrastructure solutions, and can spend more time concentrating on implementing their application-specific business logic. In such a case, these developers need only to understand the business-level components.

The invention has been described with reference to specific implementations. Other implementations of the invention will be apparent to those of ordinary skill in the art. For example, the functionality of the software architecture 100 can be used for any type of software application, not just business applications. It is, therefore, intended that the scope of the invention not be limited to the implementations described above.

1. A software architecture comprising:
a manager object capable to
receive a client request,
select an adapter object from a plurality of adapter object types that is appropriate for handling the client request, and
delegate the client request to the selected adapter object; and
a plurality of adapter objects, each adapter object capable to receive the client request if the adapter object is appropriate for handling the client request,
select an application component from a plurality of application component types that is appropriate for processing the client request, and
delegate the client request to the selected application component.

2. The software architecture of claim 1, wherein the manager object is further capable to retrieve data from a manager configuration that is used to select the adapter object that is appropriate for handling the client request.

3. The software architecture of claim 1, wherein the adapter object is further capable to retrieve data from an adapter configuration that is used to select the application component that is appropriate for processing the client request.

4. The software architecture of claim 1, wherein the software architecture is implemented on an object-oriented programming platform.

5. The software architecture of claim 4, wherein the manager object is an instantiation of a manager class and the plurality of adapter objects are instantiations of one or more adapter classes.

6. The software architecture of claim 4, wherein the object-oriented programming platform is Java or Microsoft®.net.

7. The software architecture of claim 1, wherein the manager object comprises a first manager object that handles navigation functionality, a second manager object that handles application functionality, and a third manager object that handles persistence functionality.

8. The software architecture of claim 1, wherein the plurality of adapter objects comprise a first set of adapter objects that handle navigation functionality, a second set of adapter objects that handle application functionality, and a third set of adapter objects that handle persistence functionality.

9. The software architecture of claim 7, wherein the manager object further comprises a fourth manager object that handles logging functionality, a fifth manager object that handles application state management functionality, a sixth manager object that handles data marshalling functionality, and a seventh manager object that handles key management functionality.

10. The software architecture of claim 8, wherein the plurality of adapter objects further comprise a fourth set of adapter objects that handle logging functionality, a fifth set of adapter objects that handle application state management functionality, a sixth set of adapter objects that handle data marshalling functionality, and a seventh set of adapter objects that handle key management functionality.

11. A software architecture comprising:
a manager class defining methods for
receiving the client request,
retrieving data from a manager configuration,
selecting an adapter class from a plurality of adapter class types based on the data from the manager configuration and the client request,
instancing an adapter object from the selected adapter class, and
delegating the client request to the selected adapter object; and
a plurality of adapter classes, each adapter class defining methods for
implementing one or more methods obtained from an adapter interface,
receiving a client request,
retrieving data from an adapter configuration,
selecting an application component class from a plurality of application component class types based on the data from the adapter configuration and the client request,
instancing an application component from the selected application component class, and
delegating the client request to the selected application component.

12. The software architecture of claim 11, further comprising:
a manager configuration that includes data specifying which adapter class to select based on the client request; and
an adapter configuration that includes data specifying which application component class to select based on the client request.

13. The software architecture of claim 11, further comprising:
an adapter interface defining methods that enable a manager object instantiated from the manager class to exchange data with an adapter object instantiated from one of the plurality of adapter classes; and
an application component interface defining methods that enable an adapter object instantiated from one of the plurality of adapter classes to exchange data with an application component instantiated from an application component class.

14. The software architecture of claim 11, wherein the software architecture is implemented on an object-oriented programming platform.

15. The software architecture of claim 14, wherein the object-oriented programming platform is Java or Microsoft .net.

16. The software architecture of claim 11, wherein the manager class comprises a first manager class that handles navigation functionality, a second manager class that handles application functionality, and a third manager class that handles persistence functionality.

17. The software architecture of claim 11, wherein the plurality of adapter classes comprise a first set of adapter classes that handle navigation functionality, a second set of adapter classes that handle application functionality, and a third set of adapter classes that handle persistence functionality.

18. The software architecture of claim 16, wherein the manager class further comprises a fourth manager class that handles logging functionality, a fifth manager class that handles application state management functionality, a sixth manager class that handles data marshalling functionality, and a seventh manager class that handles key management functionality.

19. The software architecture of claim 17, wherein the plurality of adapter classes further comprise a fourth set of adapter classes that handle logging functionality, a fifth set of adapter classes that handle application state management functionality, a sixth set of adapter classes that handle data marshalling functionality, and a seventh set of adapter classes that handle key management functionality.

20. The software architecture of claim 12, wherein the manager configuration and the adapter configuration are designed to be modified by a user.

21. The software architecture of claim 11, wherein the plurality of application component class types is provided by a user.

22. The software architecture of claim 11, wherein the manager class defines a functional method relevant to the client request that can be delegated to the selected application component.

23. A method for providing application functionality to a client comprising:
receiving a client request with a manager object;
selecting an adapter object from a plurality of adapter object types that is appropriate for handling the client request;
delegating the client request from the manager object to the selected adapter object;
selecting an application component from a plurality of application component types that is appropriate for processing the client request;
delegating the client request from the adapter object to the selected application component to be processed;
receiving application functionality back from the selected application component; and
providing the application functionality to the client.

24. The method of claim 23, further comprising retrieving data from a manager configuration that specifies which adapter class to select based on the client request.

25. The method of claim 23, further comprising retrieving data from an adapter configuration that specifies which application component to select based on the client request.

26. The method of claim 23, further comprising:
providing a manager class that defines methods for receiving a client request, selecting an adapter class, and delegating the client request; and
instancing the manager class to provide the manager object.

27. The method of claim 23, further comprising:
providing an adapter class that defines methods for receiving a client request, selecting an application component class, and delegating the client request; and
instancing the adapter class to provide the adapter object.

28. The method of claim 23, further comprising:
implementing one or more methods obtained from an adapter interface in the adapter object, wherein the methods enable the manager object to exchange data with the adapter object.

29. The method of claim 26, wherein providing a manager class comprises providing a first manager class that handles navigation functionality, a second manager class that handles application functionality, and a third manager class that handles persistence functionality.

30. The method of claim 29, wherein providing a manager class further comprises providing a fourth manager class that handles logging functionality, a fifth manager class that handles application state management functionality, a sixth manager class that handles data marshalling functionality, and a seventh manager class that handles key management functionality.

31. The method of claim 27, wherein providing an adapter class comprises providing a first set of adapter classes that handle navigation functionality, a second set of adapter classes that handle application functionality, and a third set of adapter classes that handle persistence functionality.

32. The method of claim 31, wherein providing an adapter class further comprises providing a fourth set of adapter classes that handle logging functionality, a fifth set of adapter classes that handle application state management functionality, a sixth set of adapter classes that handle data marshalling functionality, and a seventh set of adapter classes that handle key management functionality.

33. The method of claim 23, wherein the client request is received from a user.

34. The method of claim 23, wherein the client request is received from a software application.

35. The method of claim 23, wherein the client request is received from another adapter object.

36. The method of claim 23, wherein the client request is received from another application component.

37. The method of claim 26, wherein the manager class defines a functional method relevant to the client request, further comprising:
delegating the functional method from the manager object to the selected adapter object, and
delegating the functional method from the adapter object to the selected application component.

38. A computer program product, physically stored on a machine-readable medium, for providing application functionality to a client, comprising instructions operable to cause a programmable processor to:
receive a client request with a manager object;
select an adapter object from a plurality of adapter object types that is appropriate for handling the client request;
delegate the client request from the manager object to the selected adapter object;
select an application component from a plurality of application component types that is appropriate for processing the client request;
delegate the client request from the adapter object to the selected application component to be processed;
receive application functionality back from the selected application component; and
provide the application functionality to the client.

39. The computer program product of claim 38, further comprising instructions operable to cause a programmable processor to retrieve data from a manager configuration that specifies which adapter object to select based on the client request.

40. The computer program product of claim 38, further comprising instructions operable to cause a programmable processor to retrieve data from an adapter configuration that specifies which application component to select based on the client request.

41. The computer program product of claim 38, further comprising instructions operable to cause a programmable processor to implement methods obtained from an adapter interface in the adapter object, wherein the methods enable the manager object to exchange data with the adapter object.

42. The computer program product of claim 38, further comprising:
a manager class that defines methods for receiving a client request, selecting an adapter class, and delegating the client request; and
instructions operable to cause a programmable processor to instance the manager class to provide the manager object.

43. The computer program product of claim 38, further comprising:
an adapter class that defines methods for receiving a client request, selecting an application component class, and delegating the client request; and
instructions operable to cause a programmable processor to instance the adapter class to provide the adapter object.

44. The computer program product of claim 42, wherein the manager class defines a functional method relevant to the client request, further comprising instructions operable to cause a programmable processor to:
delegate the functional method from the manager object to the selected adapter object, and
delegate the functional method from the adapter object to the selected application component.

45. A data processing system comprising:
means for receiving a client request with a manager object;
means for selecting an adapter object from a plurality of adapter object types that is appropriate for handling the client request;
means for delegating the client request from the manager object to the selected adapter object;
means for selecting an application component from a plurality of application component types that is appropriate for processing the client request;
means for delegating the client request from the adapter object to the selected application component to be processed;
means for receiving application functionality back from the selected application component; and
means for providing the application functionality to the client.

46. The system of claim 45, further comprising means for retrieving data from a manager configuration that specifies which adapter class to select based on the client request.

47. The system of claim 45, further comprising means for retrieving data from an adapter configuration that specifies which application component to select based on the client request.

48. The system of claim 45, further comprising means for implementing one or more methods obtained from an adapter interface in the adapter object, wherein the methods enable the manager object to exchange data with the adapter object.

49. A software architecture comprising a framework for an application program to interact with a technical infrastructure built on a Java 2 Enterprise Edition platform.

50. The software architecture of claim 49, further comprising structural code that substantially separates software application concerns from technical infrastructure concerns.

51. The software architecture of claim 49, further comprising structural code that substantially separates application components from technical components.
